(19) United States
(12) Patent Application Publication
(10) Pub. No.: US 2008/0035214 A1
(43) Pub. Date: Feb. 14, 2008

(54) Refillable Dosing Valve

(76) Inventors: Rex McCormack, Tairua (NZ); Hamish William Hamilton, Christchurch (NZ)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/571,409

(22) PCT Filed: Jul. 6, 2005
(86) PCT No.: PCT/NZ05/00158

§ 371 Date: Dec. 28, 2006

(30) Foreign Application Priority Data
Jul. 6, 2004 (NZ) 532150
Jun. 8, 2005 (NZ) 540629

(51) Int. Cl. F16K 21/04

(52) U.S. Cl. 137/511

(57) ABSTRACT

A refillable external dosing valve for use in dispensing a hydrocarbon fuel for a gas auto-feed drive tool. The re-fillable dosage valve includes an entry point (5) and a non-return valve so that a fuel canister (2) is able to be reloaded after the fuel bag internally of the canister has been totally deflated. The valve is adapted to engage the canister in a manner allowing the valve to establish fluid communication with the fuel in the canister and co-operate with a refilling nozzle of apparatus adapted to deliver a substance from a reservoir through the dosing valve to refill a receptacle with said substance. The valve is also configured to include an internal metering chamber which enables a predetermined amount of fuel to be delivered to a metering chamber within the gas auto-feed drive tool. Residual gas within the canister can also be removed when the canister is to be disposed of.

### TECHNICAL FIELD

This invention relates to a refillable external dosing valve for use with a fuel cell, aerosol can, or dispenser for a dispensable fluid. In particular, the invention relates to a refillable external dosing valve for use to dispense a hydrocarbon fuel for a gas auto-feed drive tool.

The refillable dosage valve includes an entry point and a non-return valve so that the fuel canister is able to be reloaded after the fuel bag internally of the canister has been totally deflated. The external refillable dosing valve is also configured to include an internal metering feature which enables a predetermined amount of fuel to be delivered to a metering chamber within the gas auto-feed drive tool. The valve is adapted to engage the fuel canister in a manner allowing the valve to establish fluid communication with the fuel in the canister.

The refillable external dosing valve is also adapted to co-operate with a refilling nozzle of apparatus adapted to deliver a substance from a reservoir through the dosing valve to refill a receptacle with said substance, with which the dosing valve is used. The invention also provides a system to enable removal of residual gas within a canister to be removed when the canister is to be disposed of.

It is envisaged however, that the refillable external dosing valve will be applicable to any commercial, industrial or domestic situation where refilling of containers used for dispensing fluids in an aerosol-type manner is required. However, the invention may have applications outside this field.

### BACKGROUND ART

A number of products are available in the market place which incorporates a valve system for dispensing a pressurized fluid in an aerosol-type manner, whether as a continuous or intermittent delivery or spray. Fly spray, perfumes, hair products, shaving products, gases and so forth are but some of the products to which spray valve technology has been applied. In particular, the technology is applied to fuel canisters for gas auto-feed drive tools.

Typically the canister is discarded after use when the canister is deemed to be empty. In fact, existing canister labeling actively teaches away from refilling the canisters and recycling in favour of disposal are purchase of replacement canisters. As a consequence, market research has shown that significant numbers of used fuel containers have being deposited in landfills and various other areas after use. However, there is always gas still within the fuel container at all times, even when the fuel bag is considered to be empty. This results in a significant amount of gas being disposed off in ways that are, at the very least, less than safe and are environmentally questionable.

Typically, a gas fuel container includes a valve which is attached to a bag containing the gas. The valve is typically made of metal, such as steel. Accordingly, it will rust and ultimately release the gas into the atmosphere.

It would be useful therefore to have a refillable and recyclable canister, such as a fuel canister, which:
1. Allowed the canister to be re-used; and thus
2. Allowed the quantity of gas-filled (or similar) containers in the market place to be accounted for at all times, and
3. If the container was damaged in any way it would enable the container to be removed from circulation; and
4. Enabled the fixed gas in the container remaining after use to be reclaimed at the end of the container's life cycle; and
5. Enabled the fuel canister itself to be recycled at the end of its usage.
6. Enabled the canisters to be shipped to any place or country and filled just before use.
7. Provided an environmentally responsible product.

It would therefore be advantageous to have an invention that offered at least some, if not all, of the advantages of the above proposed option. It is therefore an object of the present invention to consider the above problems and provide at least one solution which addresses a plurality of these problems. It is therefore one object of the present invention to at least provide the public with a useful choice or alternative system.

A further object of the present invention is to provide a safe and easy method of recycling empty canisters as opposed to the canisters being dumped. In addition, it allows for canisters taken out of circulation to be subsequently disposed of in a safer manner.

It is also an object of the present invention to provide apparatus enabling refilling of the canisters in a manner which enables the canisters to be re-used.

Further aspects and advantages of the present invention will become apparent from the ensuing description which is given by way of example only. It should be appreciated that variations to the described embodiments are possible and would fall within the scope of the present invention.

### DISCLOSURE OF INVENTION

This invention relates to a refillable external dosing valve for use with a fuel cell, aerosol can, or dispenser for a dispensable fluid where the fluid is retained under pressure, but is able to be released on opening of a valve system to let out a stream, spray, spurt or similar of the contents of the canister in either or both a continuous flow or in intermittent spurts.

In particular, the invention relates to a refillable external dosing valve for use to dispense a hydrocarbon fuel for a gas auto-feed drive tool. Whilst the present invention is described with reference to this embodiment, it should be appreciated that the invention has application, or may be adapted for application with any canister or container which includes a valve and delivers a quantity of a flowable substance able to be delivered in such a manner as described herein. Typically the contents of the canister will be a fluid (whether a liquid or a gas). However, other flowable substances should also be considered.

The fluid is typically retained in the canister or container under pressure and can be applied for use when a release mechanism is operated. The fluid may be released continuously or intermittently, or both depending on the release mechanism used or the pressure applied to the release mechanism. The fluid may be a liquid, a gas, a suspension and so forth as typically contained within such canisters or containers; of which fly spray, foaming cream, hair products, perfumes and so forth are merely some examples.

It is envisaged therefore, that the refillable external dosing valve will be applicable to any commercial, industrial or domestic situation where refilling of containers used for dispensing fluids in an aerosol-type manner is required.

The following description shall for ease be directed to a valve configured for use with a fuel canister. In particular, the description will relate to a valve for use with a fuel canister in an engaged position, in which the valve has established fluid communication with the fuel canister.

A fuel canister typically includes the canister body, an internal fuel bag for holding a gas, a gas space between the bag and the internal surface of the canister (also typically filled with the same gas as in the bag to apply pressure to the bag contained gas) and a dispensing valve body.

The valve body of the present invention preferably incorporates an orifice which allows fluid to flow from a reservoir under pressure and through a non-return valve in to the canister so that the fuel canister is able to be reloaded after the bag has been totally deflated.

The valve includes a body having a principal formation and shape adapted for maintaining an engaged position between the valve body and the canister and also the shape allowing an external filling apparatus to effect a regulated injection of fuel through the orifice at a point within the body of the valve, such as at the back of the external dosage valve.

According to one aspect of the present invention, there is provided a method of using an external metering valve with a fuel canister for use in a gas auto-feed drive tool, including, an external refillable dosage valve and a separate fuel canister which will be recycled where possible; an entry point through a non return valve of the refillable dosage valve so that the fuel canister is able to be reloaded after the fuel bag internally of the canister has been totally deflated, and providing said external refillable dosing valve with an internal metering a biased reciprocating valve stem until said chamber which is sealed by stem is depressed to overcome said bias; inserting the valve onto the fuel canister into an engaged position, allowing the valve to establish fluid communication with the fuel canister; securing the combined valve and fuel cell into a gas auto-feed drive tool for use; and pressing the valve simultaneously and securing into an engaged position within the gas auto-feed drive tool, whereby the valve has established fluid communication with the fuel canister for filling the metering chamber (within the gas auto-feed drive tool); with fuel.

According to another aspect of the present invention there is provided an external refillable dosing valve having a front end and a back end with the both ends being fully depressed onto the fuel canister and being at all times in a fully engaged position.

According to another aspect of the present invention there is provided an external refillable dosing valve substantially as described above wherein there is provided at the back end of the external refillable dosing valve, an orifice to which an external filling apparatus is able to effect a regulated dose through the said external dosing valve when in the engaged position.

According to another aspect of the present invention there is provided a method of using an external refillable dosing valve with a fuel cell for use in a gas auto-feed drive tool, including: providing an external refillable dosing valve and a separate fuel canister;
providing said external refillable dosing valve with an internal metering chamber which is sealed by a biased reciprocating valve stem until said stem is depressed to overcome said bias;
inserting the valve onto the fuel canister so that it achieves a fully engaged position; pushing the valve into an engaged position in which fuel is transferred from said fuel canister into said metering chamber; and
once in said engaged position, inserting the combined valve and fuel cell into the gas auto-feed drive tool for use;
   whereby in the engaged position, the valve has established fluid communication with the fuel canister, and proceeds filling said metering chamber with fuel.

According to another aspect of the present invention there is provided a method of using an external refillable dosing valve with a fuel cell for use in a gas auto-feed drive tool substantially as described above, said method including:
providing an external refillable dosing valve, where the valve has an orifice for refilling the said fuel canister at the back of said valve, and a separate fuel canister;
providing said refillable dosing valve with an internal metering chamber which is sealed by a biased reciprocating valve stem until said stem is depressed to overcome said bias; pushing the valve downward onto the fuel canister, engaging the formation with the fuel canister in an engaged position; and
once in said engaged position, placing the valve and fuel canister into the gas auto-feed tool for use;
   whereby in the engaged position, the valve has established fluid communication with the fuel canister, and proceeds filling said dosing chamber with fuel.

According to another aspect of the present invention there is provided a valve configured for use with a fuel canister in the engaged position, in which the valve has established fluid communication with the fuel cell, said valve including:
a valve body for maintaining the engaged position, and,
a dosing chamber in said valve body configured for receiving a determined quantity of fuel from the fuel cell in the engaged position, said metering chamber including a biased valve stem which seals said chamber until said stem is subjected to a force which overcomes said bias.

According to another aspect of the present invention there is provided a valve configured for use with a fuel canister substantially as described above, wherein said valve further includes:
a valve body having separate front and back fixing anchor, said anchors being arcuate in cross-section when viewed from below.

According to another aspect of the present invention there is provided a valve configured for use with a fuel canister substantially as described above: said valve body having at least two anchor points; and the said two anchor points having the first formation, and said orifice located at rear off valve body for filling fuel canister.

According to another aspect of the present invention there is provided a valve configured for use with a fuel canister substantially as described above wherein the valve further includes: said first formation is an anchor lip configured for holding said valve body in the engaged position; and said second formation is an orifice configured for filling said valve fuel in the engaged position into said fuel canister.

According to another aspect of the present invention there is provided a valve configured for use with a fuel canister substantially as described above wherein the valve is configured for use with a fuel cell in both an engaged position, in which the valve has established fluid communication with the fuel cell; a valve body having a front end having a biased valve stem projecting therefrom, said stem being in fluid communication with a metering chamber and a back end; said two anchor lips at said front and back ends being configured to be frictionally secured to a rolled seam of the fuel cell in the engaged position.

According to another aspect of the present invention there is provided a valve configured for use with a fuel canister substantially as described above wherein said front and back end of said valve body is locked above said fuel cell in the engaged position, and being fixed into the engaged position when the fuel cell is operationally placed in a power tool and said valve body is pushed by a tool component into the engaged position.

According to another aspect of the present invention there is provided a combined fuel canister and valve, comprising: A cylindrical canister with a rolled seam at one end;
said rolled seam defining a generally circular space circumscribing a spigot;
a valve body having engageable anchor lips with said rolled seam for maintaining a engaged position for allowing fluid communication between said nozzle and said valve body; and said valve body having separate front and back anchor lips;

According to another aspect of the present invention there is provided a valve configured for use with a fuel canister substantially as described above wherein the combined fuel cell and valve further includes: said valve body having two anchor lips.

According to another aspect of the present invention there is provided a valve configured for use with a fuel canister substantially as described above wherein he combined fuel cell and valve of claim 12, further comprising: said formation is a groove configured for holding said valve body in the engaged position to said rolled seam.

According to another aspect of the present invention there is provided a valve configured for use with a fuel canister substantially as described above wherein the combined fuel container and valve formation is the final formation.

According to another aspect of the present invention there is provided a valve configured for use with a fuel canister substantially as described above wherein the valve incorporates an orifice which allows fluid to flow through a non return valve so that the fuel canister is able to be reloaded after the bag has been totally deflated.

The listed items above meet all requirements for a new external dosing valve for a fuel canister, which features a valve that is mounted to the fuel canister fully engaged for shipping purposes, without any gas in the bag.

In one embodiment of the present invention, the valve has two anchors shaped to allow the valve to be locked in a fully engaged position ready for shipping. Once the valve is operationally engaged on the fuel canister, gas can be added to the bag at any time, the fuel canister may then be installed into a gas auto-feed drive tool in a conventional manner.

The present invention is directed to simplifying the engaging process and makes the valve user friendly.

Further, in this embodiment the valve is not exposed to the effects of the fuel inside the fuel canister while being shipped, which results in a longer useful life for the fuel canister.

In addition, with this embodiment the shape of the anchors on the valve body allow it to be secured in a fully engaged position on the fuel canister for shipping.

According to other embodiments of the present invention, the valve body consists of two anchors, shaped in a way to meet a crimped cup curvature of the fuel canister, and to allow the engagement of the valve directly into a gas auto-feed drive tool. The front and back valve body anchors are inserted under the rim of the fuel canister, which allows the valve to be fully engaged with the fuel canister spigot.

This provides the advantage of being simple to use, because no additional action is needed to engage the valve with the fuel cell. This means the valve is correctly attached to the fuel canister, prior to installation in a tool.

More specifically, the present invention provides a valve configured for use with a fuel canister in an engaged position, in which the valve is fixed in an operational position, and the valve has established fluid communication with the fuel canister.

The valve contains a body with a formation maintaining the engaged position. In the embodiment, the valve body has one anchor formation defined thereon. The formation is a groove front and back configured for holding the valve body in the engaged position.

According to another embodiment, the valve body has an anchor attached to the front end and back end of the valve body, and the anchors are configured to be frictionally secured by a lip to a rolled seam of the fuel canister in the engaged position. Where upon the valve and canister are ready for installation in the gas auto-feed drive tool.

The present invention is therefore designed to be attached to a fuel canister and is adapted to deliver a measured dose of fuel when a release mechanism is activated, such as with each separate depression of a discharge spigot.

To distinguish between products with which the refillable dosage valve is used, valves for different fluids or for different applications may be varyingly coloured.

In addition, preferably the canisters are of a thickness to withstand repeated use and refilling, as are the internal bags which retain the fluid.

There is also provided with the invention a traveling cap which can be placed over the refillable dosage valve to protect it during transportation, or when it is not being used.

The present invention is therefore differentiated from many existing products by virtue of the inclusion of an additional port for the purpose of refilling the canister without having to remove the dosage valve. The configuration of the valve is directed to offering the ability to refill canisters, to offering an environmentally friendly alternative to existing systems and to offering improved safety in handling.

Used canisters having reached a recommended use life can be withdrawn from circulation. The gas internally of the canister, between the canister body and the fluid containing internal bag, may be removed and the canister metal recycled.

It should further be appreciated that in describing the present invention there is by extension, reference to apparatus for use in refilling a canister via a refillable dosage valve. Said apparatus adapted to refill at least one canister by engagement of a refilling nozzle with a refilling port of the refillable dosage valve. The apparatus also adapted to be in communication with at least one reservoir of a fluid and to also include a metering system enabling a predetermined quantity of the said fluid to be transferred from the reservoir to the canister. Fluid from a reservoir is transferred through at least one conduit to the dosage valve. Given the contents of the canister are pressurised for use the apparatus is also adapted to provide the fluid to the canister in a pressurised manner.

The apparatus may optionally include recording means to record the number of times a canister has been refilled, thereby enabling refilling of the canister only for a predetermined and preferred number of refills (say 10 or 12) before the canister is considered to have reached its reasonable use duration and is removed from circulation.

As can be appreciated such a recordal system would enable each canister made to have a code by which it is identifiable in terms of the date it was manufactured and where it was manufactured; and/or where it was last refilled and enable information to then be found on how many times it had been refilled. Such information would enable tracking of the canisters and follow-up on illegally dumped ones.

It should also be appreciated that in describing the present invention there is by extension, reference to apparatus for use in engaging the dosage valve with the canister in a fluid tight manner and said engagement including the method steps and configuration of the dosage valve, as described herein.

Whilst some varying embodiments of the present invention have been described, it should further be appreciated different embodiments, uses, and applications of the present invention also exist. A couple of embodiments of the present invention will now be given by way of example only, to help better describe and define the present invention. However, describing the specified embodiments should not be seen as limiting the scope of this invention.

### BRIEF DESCRIPTION OF DRAWINGS

Further aspects of the present invention will become apparent from the following description, given by way of example only and with reference to the accompanying drawings in which:

FIG. 1 is a perspective front view of one preferred embodiment of the present invention; and

FIG. 2 is a rear view of the invention represented in FIG. 1 in accordance with that preferred embodiment of the present invention; and

FIG. 3 is a front view of the invention represented in FIG. 1 in accordance with that preferred embodiment of the present invention; and

FIG. 4 is a side view of the invention represented in FIG. 1 in accordance with that preferred embodiment of the present invention; and

FIG. 5 is a bottom plan view of the invention represented in FIG. 1 in accordance with that preferred embodiment of the present invention; and

FIG. 6 is a top plan view of the invention represented in FIG. 1 in accordance with that preferred embodiment of the present invention.

### BEST MODES FOR CARRYING OUT THE INVENTION

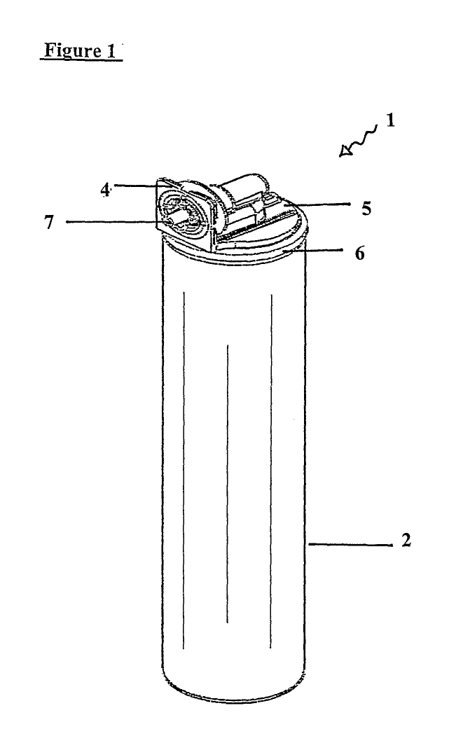

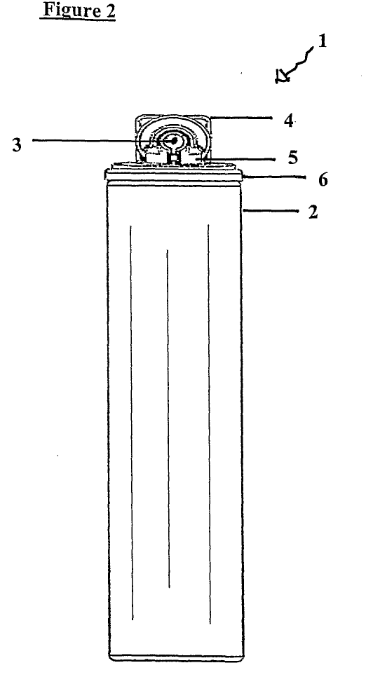

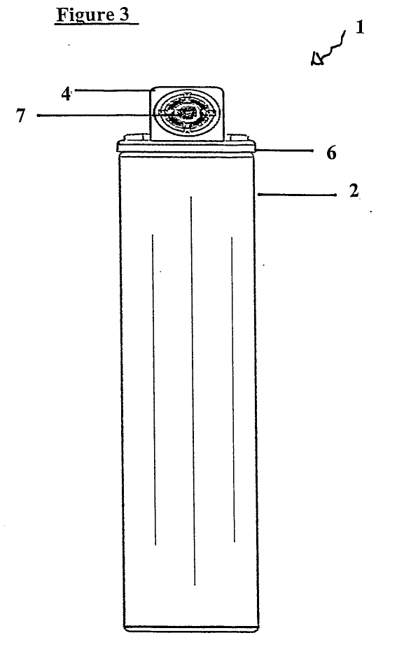

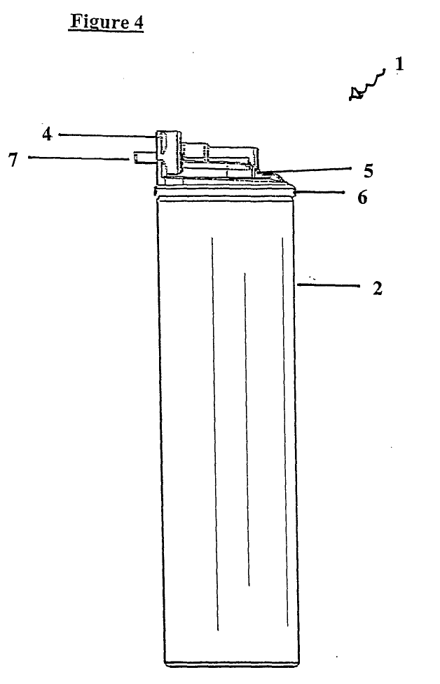

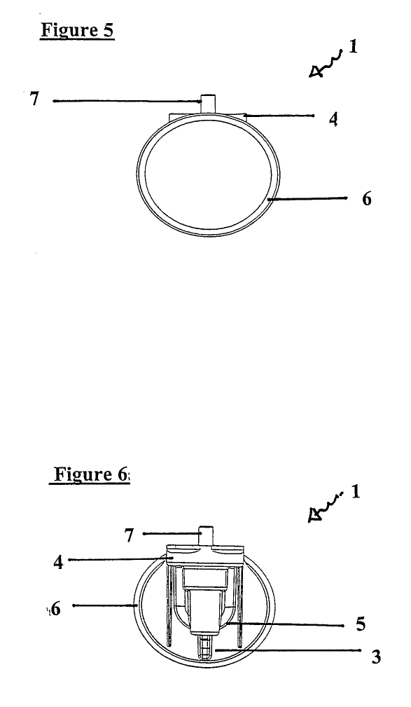

With reference to the diagrams (FIGS. 1 to 6) by way of example only there is provided a refillable external dosing valve for use with a fuel cell, aerosol can, or dispenser for a dispensable fluid where the fluid is retained under pressure, but is able to be released on opening of a valve system to let out a stream, spray or similar of the fluid in either or both a continuous flow or in intermittent spurts.

In particular, the invention relates to a refillable external dosing valve 1 for use in dispensing a hydrocarbon fuel for a gas auto-feed drive tool.

FIGS. 1 to 6 illustrate one possible embodiment of the lifting means. A fuel canister typically includes the canister body 2, an internal fuel bag for holding a gas, a gas space between the bag and the internal surface of the canister (also typically filled with the same gas as in the bag to apply pressure to the bag contained gas) and a dispensing valve body.

The valve body of the present invention preferably incorporates an orifice 3 which allows fluid to flow through a non-return valve in to the canister so that the fuel canister is able to be reloaded after the bag has been totally deflated.

The valve includes a body having a principal formation within the shape for maintaining and engaged position between the valve body and the canister and also the shape allowing an external filling apparatus to effect a regulated injection of fuel through the orifice at the back of the external dosage valve.

The method of using an external metering valve with a fuel canister for use in a gas auto-feed drive tool, includes using an external refillable dosage valve and a separate fuel canister which will be recycled where possible. There is an entry point through a non return valve of the refillable dosage valve so that the fuel canister is able to be reloaded after the fuel bag internally of the canister has been totally deflated.

The external refillable dosing valve is provided with an internal metering a biased reciprocating valve stem until said chamber which is sealed by stem is depressed to overcome said bias. The valve is inserted onto the fuel canister into an engaged position, allowing the valve to establish fluid communication with the fuel canister. The combined valve and fuel cell is then secured into a gas auto-feed drive tool for use.

The valve is pressed simultaneously and secured into an engaged position within the gas auto-feed drive tool, whereby the valve has established fluid communication with the fuel canister for filling the metering chamber (within the gas auto-feed drive tool) with fuel.

The external refillable dosing valve has a front end 4 and a back end 5 with the both ends being fully depressed onto the fuel canister and being at all times in a fully engaged position.

At the back end of the external refillable dosing valve, there is an orifice to which an external filling apparatus is able to effect a regulated dose through the said external dosing valve when in the engaged position.

When using the external refillable dosing valve with a fuel cell for a gas auto-feed drive tool, there is the external refillable dosing valve and a separate fuel canister. The external refillable dosing valve is provided with an internal metering chamber which is sealed by a biased reciprocating valve stem until said stem is depressed to overcome said bias. The valve is inserted onto the fuel canister so that it achieves a fully engaged position. The valve is pushed into an engaged position in which fuel is transferred from said fuel canister into said metering chamber; and once in said engaged position, the combined valve and fuel cell is inserted into the gas auto-feed drive tool for use. In the engaged position, the valve has established fluid communication with the fuel canister, and proceeds with filling said metering chamber of the tool with fuel.

The valve having established fluid communication with the fuel cell, has a valve body for maintaining the engaged position, and a dosing chamber in said valve body configured for receiving a determined quantity of fuel from the fuel cell in the engaged position. The said metering chamber includes a biased valve stem which seals the chamber until said stem is subjected to a force which overcomes said bias.

The valve body further includes separate front and back fixing anchor means 6, said anchors being arcuate in cross-section when viewed from below.

The valve body has at least two anchor points. The first being an anchor lip configured for holding said valve body in the engaged position; and the second being an orifice configured for filling said valve fuel in the engaged position into said fuel canister

The valve is configured for use with a fuel cell in an engaged position, in which the valve has established fluid communication with the fuel cell and the valve body has a front end having a biased valve stem projecting therefrom (said stem being in fluid communication with a metering chamber), and a back end and the two anchor lips at said front and back ends are configured to be frictionally secured to a rolled seam of the fuel cell when in the engaged position.

The front and back end of said valve body is locked above said fuel cell in the engaged position, and is fixed into the engaged position when the fuel cell is operationally placed in a power tool where the valve body is pushed by a tool component into the engaged position.

The invention as illustrated in the figures shows a combined fuel canister and valve, comprising a cylindrical canister with a rolled seam at one end;
said rolled seam defining a generally circular space circumscribing a spigot;
a valve body having engageable anchor lips with said rolled seam for maintaining a engaged position for allowing fluid communication between dispensing means 7 at the front end of the valve and said valve body; and said valve body having separate front and back anchor lips;

In the combined fuel cell illustrated the valve body has two anchor lips and a groove configured for holding the valve body in the engaged position to the rolled seam.

The valve incorporates an orifice which allows fluid to flow through a non-return valve so that the fuel canister is able to be reloaded after the internal fuel bag inside the canister has been totally deflated.

The external dosing valve for a fuel canister also features a valve that is mounted to the fuel canister fully engaged for shipping purposes, without any gas in the bag. The valve has two anchors shaped to allow the valve to be locked in a fully engaged position ready for shipping. Once the valve is operationally engaged on the fuel canister, gas can be added to the bag at any time, the fuel canister may then be installed into a gas auto-feed drive tool in a conventional manner.

The present invention is directed to simplifying the engaging process and makes the valve user friendly.

Further, in this embodiment the valve is not exposed to the effects of the fuel inside the fuel canister while being shipped, which results in a longer useful life for the fuel canister.

In addition, with this embodiment the shape of the anchors on the valve body allow it to be secured in a fully engaged position on the fuel canister for shipping.

The two anchors of the valve body are shaped in a way to meet a crimped cup curvature of the fuel canister and to allow the engagement of the valve directly into a gas auto-feed drive tool. The front and back valve body anchors are inserted under the rim of the fuel canister, which allows the valve to be fully engaged with the fuel canister spigot.

Whilst the present description and figures to which it relates are directed to a refillable dosage valve for use with a fuel canister for a tool, it should be appreciated that the present invention lends itself to more than one application. Hence, the invention may be adapted for use with a range of canisters containing a range of products, through a change to one or more of any structural feature, dimension, and so forth. As can be appreciated a variety of different embodiments, uses, and applications of the present invention therefore exist, even within the ambit of the above described invention.

Therefore, the refillable dosage valve and the resultant refillable and recyclable canister of the present invention have potentially realisable benefits over prior art systems in that it provides as listed below, alone or in combination:
1. Allows the quantity of gas-filled (or similar) containers in the market place to be accounted for at all times, and
2. If the container is damaged in any way it enables the container to be removed from circulation; and
3. Enables the fixed gas in the container remaining after use to be reclaimed at the end of the container's life cycle; and
4. Enables the fuel canister itself to be recycled at the end of its usage.
5. Enables the canisters to be shipped to any place or country and filled just before use.
6. Provides an environmentally responsible product.

It should also be understood that the term “comprise” where used herein is not to be considered to be used in a limiting sense. Accordingly, ‘comprise’ does not represent nor define an exclusive set of items, but includes the possibility of other components and items being added to the list.

This specification is also based on the understanding of the inventor regarding the prior art. The prior art description should not be regarded as being an authoritative disclosure of the true state of the prior art but rather as referring to considerations in and brought to the mind and attention of the inventor when developing this invention.

Aspects of the present invention have been described by way of example only and it should be appreciated that modifications, additions and variations to and from the above described embodiments may be made without deviating from the scope of the present invention.

1. A refillable dosage valve for use with a canister containing a fluid under pressure, said valve including a body adapted to engage with an opening of the canister, and when engaged said valve being in communication with the contents of the canister when filled, said body including an orifice adapted to co-operate with external filling apparatus and including nonreturn means to enable directional filling of the canister with the fluid when said canister is empty.

2. A refillable dosage valve as claimed in claim 1, wherein the body of the valve also includes a front portion and a back portion.

3. A refillable dosage valve as claimed in claim 2, wherein the back portion includes the orifice and the front portion includes dispensing means for dispensing the contents of the canister.

4. A refillable dosage valve as claimed in claim 3, wherein the dispensing means includes metering means to meter dispensing of the contents of the canister.

5. A refillable dosage valve as claimed in claim 4, wherein the dispensing means is adapted to dispense the contents of the canister via operation of a biased reciprocating valve stem.

6. A refillable dosage valve as claimed in claim 5, wherein operation of the biased reciprocating valve stem is effected by depression of the valve stem to overcome the bias and allow fluid flow from the canister through the dispensing means.

7. A refillable dosage valve as claimed in claim 6, wherein the valve is an external metering valve for attachment to a fuel canister for use in a gas auto-feed drive tool.

8. A refillable dosage valve as claimed in claim 7, wherein the fuel canister includes a fuel cell internally of the canister which contains the fuel when the fuel canister is filled.

9. A refillable dosage valve as claimed in claim 2, wherein said valve body includes anchor means for engaging the valve body with either or both the canister or a fuel cell within the canister.

10. A refillable dosage valve as claimed in claim 9, wherein the fuel cell includes a rolled seam.

11. A refillable dosage valve as claimed in claim 9, wherein the anchor means are substantially arcuate providing a groove configured for holding said valve body in an engaged position with said rolled seam.

12. A refillable dosage valve as claimed in claim 9, wherein engagement of the anchor means with the rolled seam of the fuel cell and/or the canister effects a combined fuel canister and valve in final engaged formation.

13. A refillable dosage valve as claimed in claim 3, wherein the orifice allows refilling of the canister with fluid after the fluid cell has been emptied.

14. A refillable dosage valve as claimed in claim 13, wherein the orifice is in communication with a non-return valve.

15. A refillable dosage valve configured for use with a fuel canister in an engaged position in which the valve has established fluid communication with the fuel cell, said valve including a valve body, said valve body including a front portion and a back portion, said front portion including a biased valve stem projecting therefrom, said stem being in fluid communication with a metering chamber, and said back portion being adapted to engage with refilling apparatus; said valve body also including anchor means configured to be frictionally secured to a rolled seam perimeter of at least the fuel cell to maintain the valve and the canister in the engaged position.

16. A refillable dosage valve for use with a fuel canister as claimed in claim 15, wherein in the engaged position the valve has established fluid communication with the fuel cell, and the biased valve stem is in fluid communication with the metering chamber ready for use.

17. A refillable dosage valve configured for use with a fuel canister as claimed in claim 16, wherein the front and back portions of the valve body are locked above said fuel cell in the engaged position, but are effected operational by placing the combined valve body and canister in a power tool such that the valve body is pushed by a tool component into the engaged position such that the biased valve stem is then in fluid communication with the metering chamber ready for use.

18. A combined fuel canister and valve, comprising: a cylindrical canister with a rolled seam at one end; said rolled seam defining a generally circular space circumscribing a spigot; a valve body having anchor means adapted to engage with said rolled seam via anchor means for maintaining a engaged position allowing fluid communication through said valve body.

19. A method of refilling a fuel canister for use in a gas auto-feed drive tool using an external refillable dosage valve and a separate fuel canister, said valve including an entry point through a non-return valve to enabling refilling of a fuel cell internally of the canister, said external refillable dosing valve also including metering means via a biased reciprocating valve stem which operates when said stem is depressed to overcome said bias; said method including the steps of inserting the valve onto the fuel canister into an engaged position, allowing the valve to establish fluid communication with the fuel canister; securing the combined valve and fuel cell into a gas auto-feed drive tool for use; and pressing the valve simultaneously and securing into an engaged position within the gas auto-feed drive tool, whereby the valve has established fluid communication with the fuel canister for filling the metering chamber (within the gas auto-feed drive tool); with fuel.

20. A method of using an external refillable dosing valve with an existing fuel cell for use in a gas auto-feed drive tool, including: providing an external refillable dosing valve and a separate fuel canister; providing said external refillable dosing valve with an internal metering chamber which is sealed by a biased reciprocating valve stem until said stem is depressed to overcome said bias; inserting the valve onto the fuel canister so that it achieves a fully engaged position; pushing the valve into an engaged position in which fuel is transferred from said fuel canister into said metering chamber; and once in said engaged position, inserting the combined valve and fuel cell into the gas auto-feed drive tool for use; whereby in the engaged position, the valve has established fluid communication with the fuel canister, and proceeds filling said metering chamber with fuel.

21. A method of using an external refillable dosing valve with a fuel cell for use in a gas auto-feed drive tool as claimed in claim 20, said method including: providing an external refillable dosing valve, where the valve has an orifice for refilling the said fuel canister at the back of said valve, and a separate fuel canister; providing said refillable dosing valve with an internal metering chamber which is sealed by a biased reciprocating valve stem until said stem is depressed to overcome said bias; pushing the valve downward onto the fuel canister, engaging the formation with the fuel canister in an engaged position; and once in said engaged position, placing the valve and fuel canister into the gas auto-feed tool for use; whereby in the engaged position, the valve has established fluid communication with the fuel canister, and proceeds filling said dosing chamber with fuel.

22. A refillable dosage valve configured for use with an existing fuel canister in the engaged position, in which the valve has established fluid communication with the fuel cell, said valve including: a valve body for maintaining the engaged position, and, a dosing chamber in said valve body configured for receiving a determined quantity of fuel from the fuel cell in the engaged position, said metering chamber including a biased valve stem which seals said chamber until said stem is subjected to a force which overcomes said bias.

23. A refillable dosage valve as claimed in claim 22, wherein the valve body includes an anchor means configured to be frictionally secured to a rolled seam of the fuel canister in the engaged position, where upon the valve and canister are ready for installation in the gas auto-feed drive tool.

24. Apparatus for use in refilling a canister via a refillable dosage valve, said apparatus adapted to refill at least one canister by engagement of a refilling nozzle with a refilling orifice of the refillable dosage valve, the apparatus also adapted to be in communication with at least one reservoir of a fluid and to also include a metering system enabling a predetermined quantity of the said fluid to be transferred from the reservoir to the canister, fluid from said reservoir being transferred through at least one conduit to the dosage valve.

25. Apparatus for use in refilling a canister via a refillable dosage valve as claimed in claim 24, wherein the apparatus is adapted to provide the fluid to the canister in a pressurised manner.

26. (canceled)
